(19) United States
(12) Patent Application Publication
(10) Pub. No.: US 2006/0231480 A1
(43) Pub. Date: Oct. 19, 2006

(54) Multi-layer filtering cartridge for filtration of liquids

(76) Inventor: Enric Palacios Donaque, Barcelona (ES)

Correspondence Address: KLAUBER & JACKSON, 411 HACKENSACK AVENUE, HACKENSACK, NJ, 07601, US

(21) Appl. No.: 11/335,180

(22) Filed: Jan. 19, 2006

(30) Foreign Application Priority Data
Jan. 19, 2005 (ES) U200500105

(51) Int. Cl. B01D 27/00

(52) U.S. Cl. 210/437; 210/497.01; 210/497.1

(57) ABSTRACT

This comprises a central tube (1) provided with vents or holes (2) for the passage of liquid, covered with a grille-type laminar support rolled in a spiral. This assembly is covered with an outer layer of porous filtering material (4) which is also rolled in a spiral with the desired number of sub-layers depending on the pore size.

The ends are sealed with circular covers (5) with an axial hole that matches the central tube (1).

### OBJECT OF THE INVENTION

As stated in the title of this specification, this invention concerns a multi-layer filtering cartridge for filtration of liquids, fundamentally water, whether brackish or sea-water, or rainwater, industrial water or water to be made fit for drinking.

It permits cleaning of liquids or water with a considerable load of suspended particles and the cartridge can also be covered with any kind of organic or inorganic load, evenly distributed over the surface of said cartridge without the slightest irregularity, in order to assist in the cleaning of liquids containing particles of colloidal size or in the form of molecular aggregates.

It is an object of the invention to obtain a much more efficient quality of separation of solids than that obtained with cartridges currently existing on the market.

Another object is to make filtration possible in both directions without there existing any differences in the quality of the filtered liquid.

### PRIOR ART OF THE INVENTION

In the treatment of water, different types of filtering cartridges are currently used which, due to the way they are constructed, very easily become blocked and do not permit cleaning by means of back-washing nor by the action of chemical products, owing to the fact that the pore size for the separation of solids from liquids becomes deteriorated with the consequent production of poor quality water.

Also, many of the filtering cartridges existing on the market do not allow homogenous coating of base layers with inorganic or organic loads or products in order to help in the separation of colloids or molecular agglomerates of the water or liquid to treat.

### DESCRIPTION OF THE INVENTION

In general terms, the multi-layer filtering cartridge for filtration of liquids, forming the object of the invention, consists of a central tube with vents or holes for the passage of liquid through it, around which is a grille-type first support rolled in a spiral which, apart from conferring good mechanical strength on the system, also achieves a homogenous distribution of the flow of the filtered liquid by acting as a separator element between the central tube and the actual filtering material itself, this filtering material consisting of a layer or blanket rolled in a spiral and formed from a porous filtering substance whose structure gives rise to a multitude of small channels formed between links strung together in the manner of a chain and with side chains, the links therefore being distributed in two perpendicular directions.

In this way, the desired pore size is achieved depending on the number of sub-layers or turns of the filtering material, in order to separate the substances in suspension required by each case. This implies a notable advantage compared to the state of the art since several sub-layers of filtering material can be superposed in order to achieve different pore sizes for the separation of thick or colloidal substances in suspension.

In turn, the structure of the filtering material can, instead of being homogenous, be formed from links of chain of different shapes and/or sizes which progressively close off the gap for the passage of liquid thereby gradually varying the pore size. So, the liquid to filter passes through different layers with each of these layers acting as an independent means of separation. This implies a high quality in the separation of solids, much more efficient than that currently achieved.

The high mechanical strength that is achieved owing to this structural arrangement of layers in the cartridge means that the filter can be washed in counter-current, in other words, in the reverse direction to that of the filtration or separation being carried out, by means of water, air or a combination of both.

Likewise, the type of materials chosen for the construction of the support and filtering means is resistant to any chemical agent which the liquid to filter might contain, such as those used in cleaning of the cartridge, for example, oxidising agents, acids, alkalis and even organic solvents.

The superposition of filtering layers rolled in a spiral of the porous filtering material used, permits a smooth outer and inner surface to be obtained of the separation or filtration packet, with minimum roughness, which makes it suitable for the homogenous coating of loads such as diatomaceous earths, powdered activated carbon, ion exchange resins, which can be used for the separation of highly colloidal substances or those in the form of molecular aggregates.

As we have said earlier, this type of cartridge permits two filtration directions, from the outside to the inside or vice versa, without there existing any differences in the quality of the filtered liquid.

The ends of the filtering cartridge thus formed are afterwards sealed with ring-shaped covers that match the central tube with vents or holes, in order to achieve watertightness of the entire assembly.

In order to facilitate an understanding of the characteristics of the invention and forming an integral part of this specification, some sheets of drawings are attached in which, by way of illustration only and not limiting, the following has been represented.

### BRIEF DESCRIPTION OF THE FIGURES

FIG. 1. Is a perspective view with a sectioned quadrant of a multi-layer filtering cartridge for filtration of liquids, forming the object of the invention.

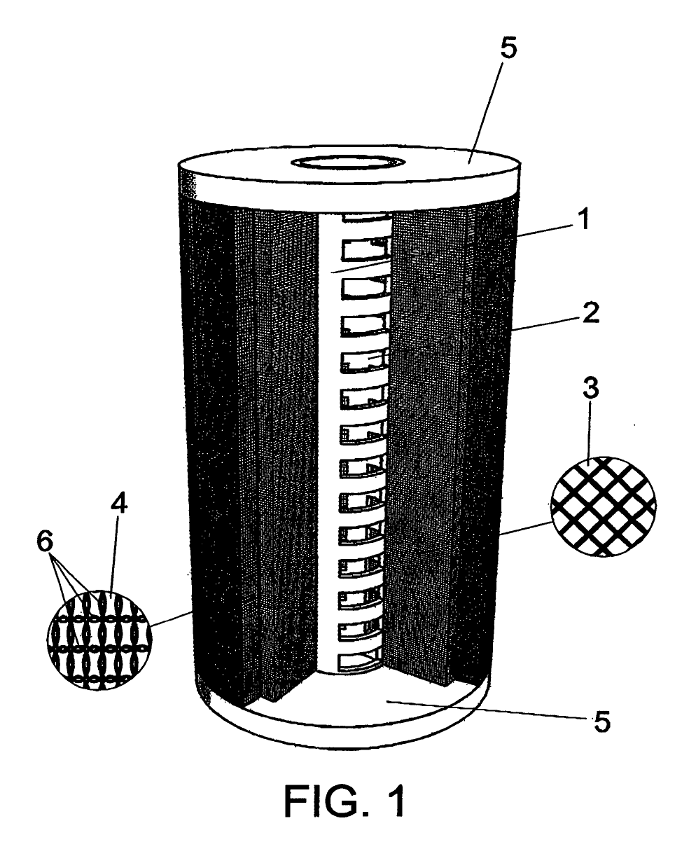

FIG. 2. Is a schematic view of the filtering cartridge functioning for filtration in the outside-inside direction.

FIG. 3. Is a view similar to that of FIG. 2, functioning in the opposite direction, in other words in the direction inside-outside.

### DESCRIPTION OF THE PREFERRED MANNER OF EMBODIMENT

Making reference to the numbering adopted in the figures, we can see how the multi-layer filtering cartridge for filtration of liquids, which the invention proposes, is comprised of a central tube 1 with vents or holes 2 around which is rolled in a spiral the grille support 3 on which is in turn rolled the layer of filtering material 4.

The bases of the cylindrical shape of the cartridge are sealed with annular shaped covers 5, the central hole of which matches the tube 1.

In this example of preferred embodiment, the filtering material 4 is formed from links 6 connected longitudinally and also transversely in order to define a kind of blanket that can be easily rolled around the layer of the grille support 3.

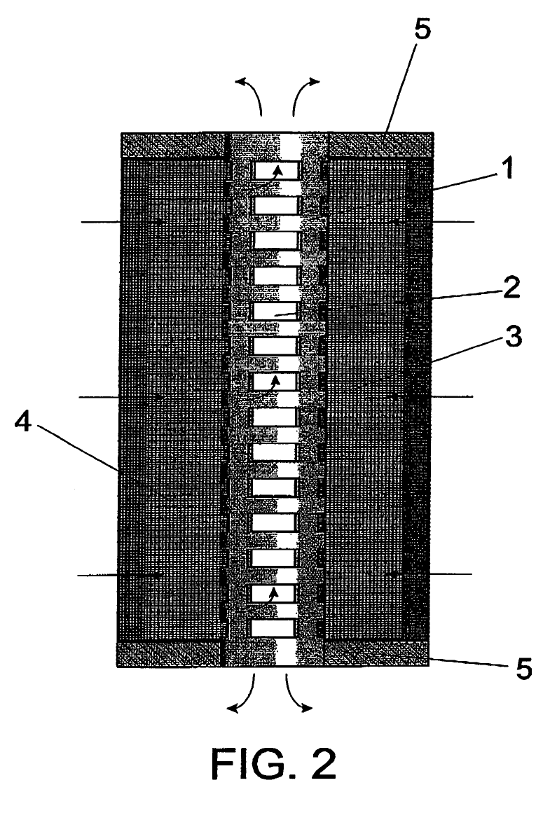

Making special reference to FIG. 2, we can see the direction of filtration (from outside to inside), where the vents or holes 2 collect the filtered water. The tube 1 collects this filtered water according to the travel shown by the arrows.

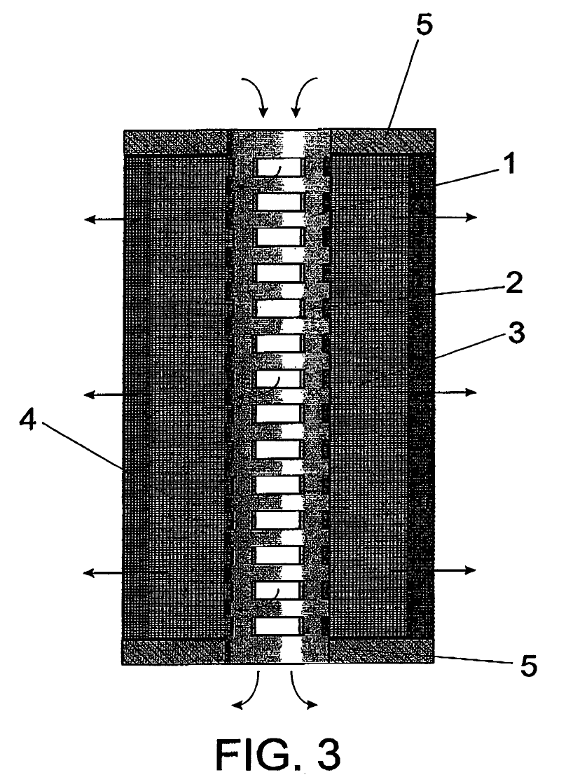

In FIG. 3, the same filtering cartridge of the invention can be observed, working in the opposite direction. The tube 1 collects the water to filter which passes through the vents or holes 2, then passing through the layers of the grille 3 and filtering material 4.

1. MULTI-LAYER FILTERING CARTRIDGE FOR FILTRATION OF LIQUIDS, wherein it is comprised on the basis of a central tube with vents or holes for passage of liquid, covered by a laminar support rolled in a spiral, of the grille type which confers good mechanical strength and homogenous distribution of the flow of the filtered liquid, also having an outside layer of porous filtering material, rolled in a spiral, the number of sub-layers of which determines the necessary pore size, this assembly being sealed at its ends with separate covers with an axial hole that matches the central tube, with both filtration directions being permitted.

2. MULTI-LAYER FILTERING CARTRIDGE FOR FILTRATION OF LIQUIDS, according to claim 1, wherein the layer of filtering material is materialised by links of chain strung together in two perpendicular directions.

3. MULTI-LAYER FILTERING CARTRIDGE FOR FILTRATION OF LIQUIDS, according claim 2, wherein the superposed layers of filtering material are of different structure by varying the size of the link and shape of the gap thereof, thus varying the pore size in a gradual manner.
